(19) United States
(12) Patent Application Publication
(10) Pub. No.: US 2017/0027383 A1
(43) Pub. Date: Feb. 2, 2017

(54) CLAM-GRILLING APPARATUS

(71) Applicant: KUO-JEN YU, CHIA I CITY (TW)

(72) Inventor: KUO-JEN YU, CHIA I CITY (TW)

(21) Appl. No.: 14/810,598

(22) Filed: Jul. 28, 2015

(51) Int. Cl. A47J 37/07

(52) U.S. Cl. CPC A47J 37/07

(57) ABSTRACT

A clam-grilling appliance includes a grilling plate, and a plurality of clam-shaped hollows are provided in the grilling plate for clams to be stably placed in. The clam-shaped hollows are suitable for various sizes of clams. Each clam-shaped hollow is provided with a bearing slope to hold the lower half shell of each clam because each bearing slope is designed to meet the curve of the lower half shell of each clam. An against wall is provided at the rear of each clam-shaped hollow to support the rear joint portion of each clam, each against wall is designed to be slightly inclined to have a gap of 1-2 mm for the upper half shell of each clam to open within the angle of 90° after being grilled, and a stopping top edge is provided at the top end of each against wall to prevent the upper half shell of a medium or large clam from opening too widely.

### BACKGROUND OF THE INVENTION

Field of the Invention

The present invention relates to a clam-grilling appliance with innovatory convenience features, and more particularly to a clam-grilling appliance which is provided with a plurality of pre-arranged clam-shaped hollows in a grilling plate so as for clams to be stably placed in the pre-arranged hollows while being grilled.

Description of the Related Art

With the people's living standards being improved, a variety of entertainment activities are held in order to meet the needs of modern life.

Particularly, it is a good time for family reunion in the festival or outdoor activities. Especially, when one is eating the barbecue food, the scent will be circulating in one's mouth.

While barbecuing food, a grill made of metal mesh is most often used among current barbecue utensils. The food, such as meat, chicken or clams, is placed on the grill first to be grilled for a little while. After being finished, the meat, chicken or clams on the grill will be gripped with a clip for being eaten.

However, a clam will easily spill its juice out of the lower half shell when the clam being grilled for a while to open its upper half shell because the clam will lose its balance on a conventional grill when the upper half shell opens. It causes much trouble in grilling clams with a conventional grill.

### SUMMARY OF THE INVENTION

Therefore, the present invention is to provide a clam-grilling appliance that substantially obviates the drawback of the related conventional art.

An objective of the present invention is to provide a clam-grilling appliance which is provided with a grilling plate, and a plurality of clam-shaped hollows for clams to be stably placed in are pre-arranged in the grilling plate.

Another objective of the present invention is to provide a clam-grilling appliance whose clam-shaped hollows may be suitable for various sizes of clams.

Still another objective of the present invention is to provide a clam-grilling appliance in which each clam-shaped hollow is provided with a bearing slope to hold the lower half shell of each clam, an against wall to support the rear joint portion of each clam and a blocking point to stop the upper half shell of each clam from opening too widely.

It is a further objective of the present invention to provide a clam-grilling appliance which can ensure each clam to be stably placed in each hollow so as to prevent the juice in each clam from spilling out when boiling.

Accordingly, a clam-grilling appliance includes a grilling plate made of metal material, pottery or porcelain clay. A plurality of pre-arranged clam-shaped hollows are provided in the grilling plate so as for clams to be stably placed in the hollows. The clam-shaped hollows are suitable for various sizes of clams. Each clam-shaped hollow is provided with a bearing slope to hold the lower half shell of each clam because each bearing slope is designed to meet the curve of the lower half shell of each clam and to keep part or whole of the lower half shell of each clam fit to each bearing slope so as to maintain each clam in a stable level state after being placed in each clam-shaped hollow. An against wall is provided at the rear of each clam-shaped hollow to support the rear joint portion of each clam when being placed in each clam-shaped hollow, each against wall is designed to be slightly inclined to have a gap of 1-2 mm for the upper half shell of each clam to open within the angle of 90° after being grilled a while, and a stopping top edge is provided at the top end of each against wall so as to prevent the upper half shell of a medium or large clam from opening too widely for the juice to spill out of the lower half shell of each clam after being grilled a while.

### BRIEF DESCRIPTION OF THE DRAWINGS

Other features and advantages of the present invention will become apparent in the following detailed description of the preferred embodiment with reference to the accompanying drawings, in which:

FIG. 1 is a perspective view of an embodiment of a clam-grilling appliance in accordance with the present invention;

FIG. 2 is a schematic top elevation view showing different sizes of clams being respectively placed in a plurality of clam-shaped hollows in an embodiment of the clam-grilling appliance in accordance with the present invention;

FIG. 3 is a cross sectional view of an embodiment of the clam-grilling appliance in accordance with the present invention;

FIG. 4 is a schematic cross sectional view showing different sizes of clams being respectively placed in a plurality of clam-shaped hollows in an embodiment of the clam-grilling appliance in accordance with the present invention;

FIG. 5 is a schematic cross sectional view showing different sizes of clams being respectively placed in a plurality of clam-shaped hollows in an embodiment of the clam-grilling appliance in accordance with the present invention after being grilled to open mouths;

FIG. 6 is a schematic cross sectional view showing a clam of medium size being placed in a clam-shaped hollow in an embodiment of the clam-grilling appliance in accordance with the present invention after being grilled to open month;

FIG. 7 is a perspective view of an embodiment of the clam-grilling appliance in accordance with the present invention being used to grill clams; and,

FIG. 8 is a schematic cross sectional view showing different sizes of clams being respectively placed in a plurality of clam-shaped hollows in an embodiment of the clam-grilling appliance in accordance with the present invention to open mouths and to be gripped by clips.

### DETAILED DESCRIPTION OF THE PREFERRED EMBODIMENT

The present invention discloses a clam-grilling appliance , and some detailed parts of process for manufacturing or processing the clam-grilling appliance are accomplished by applying prior art. Therefore , these parts will not be completely depicted in the description below. The drawings referred in the following are not made according to the actual related sizes, and the function of these drawings is only for illustrating characteristics related to the present invention.

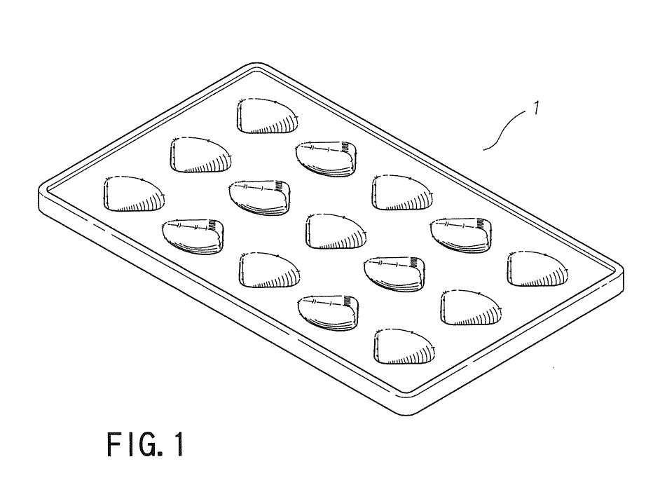

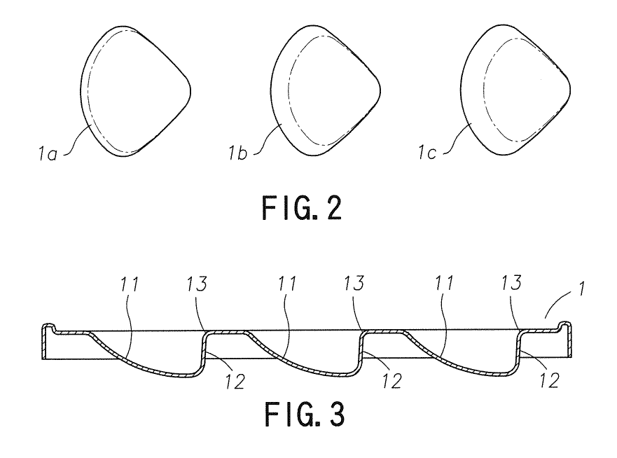

FIG. 1 is a perspective view of the preferred embodiment of the clam-grilling appliance according to the present invention. The clam-grilling appliance is integrally made to be a grilling plate 1, which may be made of metal material, pottery or porcelain clay, a plurality of clam-shaped hollows 1a, 1b, and 1c are disposed in the grilling plate 1, as shown in FIG. 2. The clam-shaped hollows 1a, 1b, 1c may receive different sizes of clams. Referring to FIG. 5, a bearing slope 11 is disposed at the bottom of each of the clam-shaped hollows 1a, 1b, 1c, an against wall 12 is disposed at the rear of each of the hollows 1a, 1b, 1c, and a stopping top edge 13 is disposed at the top end of each against wall 12.

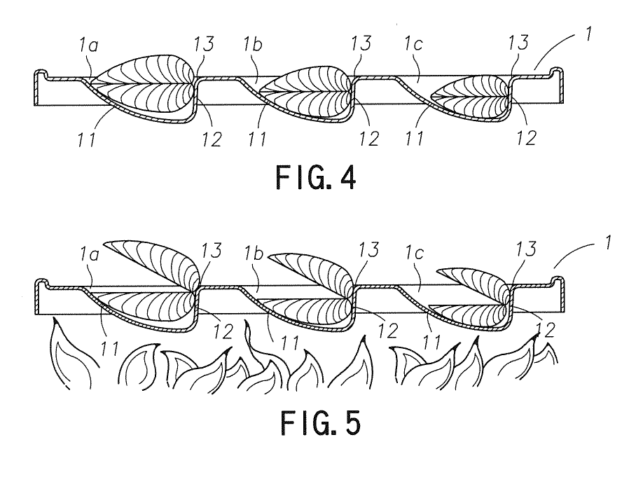

Referring to FIGS. 3 and 4, each bearing slope 11 of the clam-shaped hollows 1a, 1b, 1c in the grilling plate 1 is designed according to the curved surface of the lower half shell of a clam, and clams are similar in appearance. Therefore, the unified bearing slopes 11 of the clam-shaped hollows 1a, 1b, 1c can meet the curved surface of the lower half shells of different sizes of clams, so as to keep part or whole of the lower half shell of each clam fit to each bearing slope 11 and to maintain each clam in a stable level state after being placed in each clam-shaped hollow 1a, 1b or 1c.

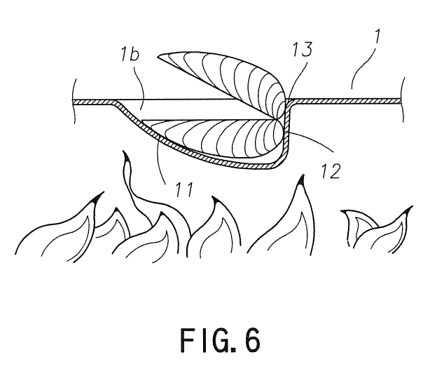

As a clam being a triangular article, each bearing slope 11 can keep the lower half shell of each clam being stably placed in each clam-shaped hollow 1a, 1b or 1c. At the same time, the rear joint portion of each clam will be against the against wall 12 of each clam-shaped hollow 1a, 1b or 1c after each clam being placed in each clam-shaped hollow 1a, 1b or 1c in order for each clam to maintain the stable level state in each clam-shaped hollow 1a, 1b or 1c. After being grilled to open, the rear end of the upper half shell of each medium or large clam will be stopped by the stopping top edge 13 of each against wall 12 of each clam-shaped hollow 1a, 1b or 1c, as shown in FIGS. 5 and 6.

Referring to FIGS. 4 and 5, when a small clam being stably placed in the clam-shaped hollow 1c, the rear joint portion of the small clam will be against the against wall 11 of the clam-shaped hollow 1c. The against wall 11 is designed to be slightly inclined so as to have a gap of 1-2 mm for the upper half shell of the small clam to open within the angle of 90° after being grilled a while. Therefore, the upper half shell of the small clam will not open too widely for the juice to spill out of the lower half shell of the small clam after the juice is boiling.

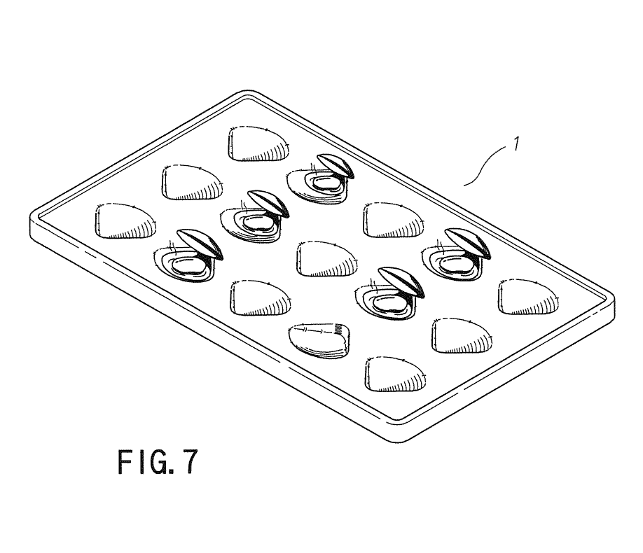

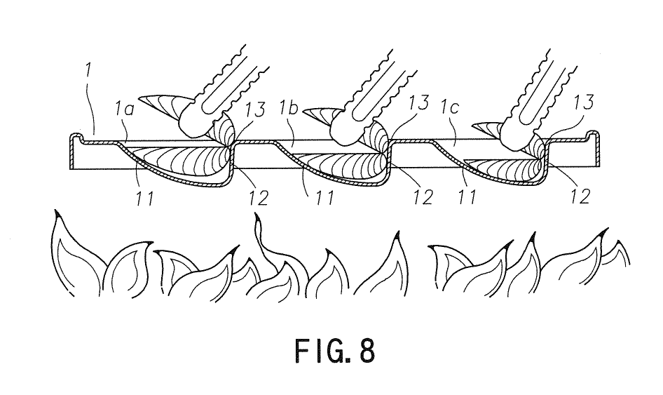

Referring to FIGS. 7 and 8, after a plurality of clams being heated a while, the upper half shells of these clams will open within the angle of 90°. After the juice in the clams being boiling, the grilling plate 1 may be carried to place on a table and then for users to pick up the clams with clips or by hands after the clams being cool.

While the preferred embodiment of the present invention has been described above, it will be recognized and understood that various modifications may be made therein, and the appended claims are intended to cover all such modifications which may fall within the spirit and scope of the present invention.

What is claimed is:

1. A clam-grilling appliance comprising:
a grilling plate being integrately formed,
a plurality of clam-shaped hollows being provided in said grilling plate for large, medium or small sizes of clams to be stably placed in, each said clam-shaped hollow being provided with a bearing slope at the bottom to hold the lower half shell of a clam in a stable level state, each said bearing slope being designed to meet the curve of the lower half shell of a clam, and an against wall being provided at the rear of each said clam-shaped hollow to support the rear joint portion of a clam stably in each said clam-shaped hollow, and a stopping top edge being provided at the top end of each said against wall.
